(19) United States
(12) Patent Application Publication
(10) Pub. No.: US 2015/0382181 A1
(43) Pub. Date: Dec. 31, 2015

(54) METHOD AND APPARATUS FOR SENDING BUSINESS CARD BETWEEN MOBILE TERMINALS AND STORAGE MEDIUM

(71) Applicant: Tencent Technology (Shenzhen) Company Limited, Shenzhen (CN)

(72) Inventors: Xi CHEN, Shenzhen (CN); Taiwei Liu, Shenzhen (CN); Peng Jiang, Shenzhen (CN); Chao Feng, Shenzhen (CN)

(21) Appl. No.: 14/752,517

(22) Filed: Jun. 26, 2015

Related U.S. Application Data
(63) Continuation of application No. PCT/CN2013/084966, filed on Oct. 10, 2013.

(30) Foreign Application Priority Data
Dec. 28, 2012 (CN) 201210583780.8

(51) Int. Cl. H04W 8/20; G06F 3/0484; H04W 76/02; G06F 3/0482; H04M 1/725; H04W 8/18

(52) U.S. Cl. CPC H04W 8/205; H04M 1/72583; H04W 8/183; H04W 76/02; G06F 3/0482; G06F 3/04842; G06F 3/04847

(57) ABSTRACT

The present disclosure provides a method performed by a sending terminal for exchanging business cards with one or more receiving terminals. According to the method, the sending terminal establishes a wireless connection with one or more receiving terminals and enters a business card exchange mode with the one or more receiving terminals; then, a receiving terminal list including user identifiers is displayed on a display of the sending terminal. After detecting a user selection operation of selecting at least one user identifier in the receiving terminal list, a business card is displayed on the display of the sending terminal. Finally, in response to a sliding operation performed on the business card on the display of the sending terminal, the sending terminal sends the business card to one receiving terminal that corresponds to the selected user identifier. Such an operation manner of sending a business card is simple and intuitive.

### RELATED APPLICATIONS

This application is a continuation application of PCT Patent Application No. PCT/CN2013/084966, entitled “METHOD AND APPARATUS FOR SENDING BUSINESS CARD BETWEEN MOBILE TERMINALS AND STORAGE MEDIUM” filed on Oct. 10, 2013, which claims priority to Chinese Patent Application No. 201210583780.8, entitled “METHOD AND APPARATUS FOR SENDING BUSINESS CARD BETWEEN MOBILE TERMINALS” filed by Tencent Technology (Shenzhen) Co., Ltd. on Dec. 28, 2012, both of which are incorporated herein by reference in their entirety.

### FIELD OF THE TECHNOLOGY

The present disclosure relates to the field of computer technologies, and in particular, to a method and an apparatus for exchanging business cards between mobile terminals and a storage medium.

### BACKGROUND OF THE DISCLOSURE

As a social tool of people, paper business cards have gained increasing popularity, which, however, leads to the consumption of a great number of paper resources. A mobile terminal (for example, a mobile phone) is an increasingly mature social communication device. However, to extend a new relationship chain on the mobile terminal, most of users need to add information such as a contact number, which is rather complex.

### SUMMARY

The embodiments of the present disclosure are to provide a method for exchanging business cards between mobile terminals, so as to solve the problem in the prior art that the exchange of personal information between mobile terminals requires complex operations.

The embodiments of the present disclosure achieve the above objective by providing a method for exchanging business cards between mobile terminals, the method including the following steps performed at a sending terminal having one or more processors and memory for storing a plurality of program units for execution by the one or more processors: establishing a wireless connection with one or more receiving terminals and entering a business card exchange mode with the one or more receiving terminals;

displaying a receiving terminal list, the receiving terminal list comprising user identifiers of the one or more receiving terminals;

displaying a business card on a display of the sending terminal in response to a user selection operation of selecting at least one user identifier in the receiving terminal list; and sending the business card from the sending terminal to the receiving terminal that corresponds to the selected user identifier through the wireless connection after receiving a sliding operation performed on the business card on the display of the sending terminal.

The business card is preferably an image stored in a mobile terminal and used for carrying personal information.

Another objective of the embodiments of the present disclosure is to provide a mobile terminal for exchanging business cards between mobile terminals, the mobile terminal including one or more processors and memory for storing a plurality of program units for execution by the one or more processors, the plurality of program units further including:

a wireless connection unit, configured to establish a wireless connection with one or more receiving terminals and enter a business card exchange mode with the one or more receiving terminals;

a display unit, configured to display a receiving terminal list, the receiving terminal list comprising user identifiers of the one or more receiving terminals, and display a business card on a display of the mobile terminal in response to a user selection operation of selecting at least one user identifier in the receiving terminal list; and

a sending unit, configured to send the business card from the mobile terminal to the receiving terminal that corresponds to the selected user identifier through the wireless connection after receiving a sliding operation performed on the business card on the display of the mobile terminal.

The business card is preferably an image stored in a mobile terminal and used for carrying personal information.

Still another objective of the embodiments of the present disclosure is to provide a non-transitory storage medium comprising a plurality of computer executable instructions, the computer executable instructions being executed by one or more processors of a sending terminal for exchanging business cards with one or more receiving terminals, the computer executable instructions further including:

establishing a wireless connection with one or more receiving terminals and entering a business card exchange mode with the one or more receiving terminals;

displaying a receiving terminal list, the receiving terminal list comprising user identifiers of the one or more receiving terminals;

displaying a business card on a display of the sending terminal in response to a user selection operation of selecting at least one user identifier in the receiving terminal list; and

sending the business card from the sending terminal to the receiving terminal that corresponds to the selected user identifier through the wireless connection after receiving a sliding operation performed on the business card on the display of the sending terminal.

According to the embodiments of the present disclosure, a sending terminal establishes a connection with a receiving terminal and enters a business card exchange mode; then, a receiving terminal list including user identifiers is displayed, and after a selection operation of selecting at least one user identifier in the receiving terminal list is received, a business card is displayed on the display of the sending terminal; then, a sliding operation performed on the business card on the sending terminal is received, and the business card in the sending terminal is sent to a receiving terminal that corresponds to the selected user identifier. Such an operation manner of sending a business card is simple and intuitive.

### BRIEF DESCRIPTION OF THE DRAWINGS

FIG. 1 is a flowchart of implementing a method for exchanging business cards between mobile terminals according to a first embodiment of the present disclosure;

FIG. 2 is a schematic diagram of an interface when a sending terminal and a receiving terminal enter a business card exchange mode according to the first embodiment of the present disclosure;

FIG. 3 is a schematic diagram of an interface of selecting a user identifier according to the first embodiment of the present disclosure;

FIG. 4 is a schematic diagram of an interface of displaying a business card on the sending terminal according to the first embodiment of the present disclosure;

FIG. 5 is a schematic diagram of an interface of receiving a checking event according to the first embodiment of the present disclosure;

FIG. 6 is a schematic diagram of an interface of sending a business card according to a second embodiment of the present disclosure; and

FIG. 7 is a structural diagram of an apparatus for exchanging business cards between mobile terminals according to a third embodiment of the present disclosure.

### DESCRIPTION OF EMBODIMENTS

To make the objectives, technical solutions, and advantages of the present disclosure clearer, the present disclosure is further described in detail below with reference to the accompanying drawings and embodiments. It should be understood that, the specific embodiments described herein are merely for explaining the present disclosure, but are not intended to limit the present disclosure.

According to the embodiments of the present disclosure, a sending terminal establishes a connection with a receiving terminal and enters a business card exchange mode; then, a receiving terminal list including user identifiers is displayed, and after a selection operation of selecting at least one user identifier in the receiving terminal list is received, a business card is displayed on the display of the sending terminal; then, a sliding operation performed on the business card on the sending terminal is received, and the business card in the sending terminal is sent to a receiving terminal that corresponds to the selected user identifier. Such an operation manner of sending a business card is simple and intuitive.

The implementation of the present disclosure is described in detail below with reference to specific embodiments.

### Embodiment 1

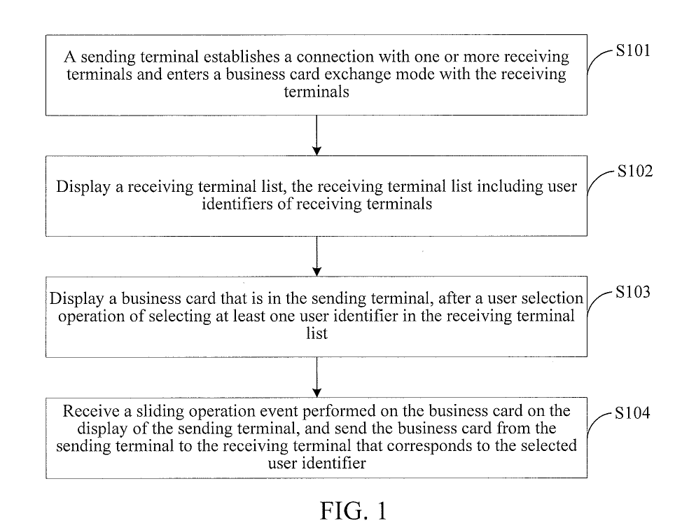

FIG. 1 shows a process of implementing a method for exchanging business cards between mobile terminals according to an embodiment of the present disclosure, including the following steps S101 to S104, which are described in detail below.

In step S101, a sending terminal establishes a connection with one or more receiving terminals and enters a business card exchange mode.

In this embodiment of the present disclosure, the business card is an image stored in a mobile terminal and used for carrying personal information. The image is preferably an editable image, so that the personal information can be easily edited, for example, the business address of a user can be changed easily if necessary. Further, the business card may be formed by pulling user information by a built-in code compilation template of the mobile terminal, which avoids complex input and simplifies the operation. The user information includes a user name of a mobile terminal, a mobile terminal number, and/or an instant messaging account.

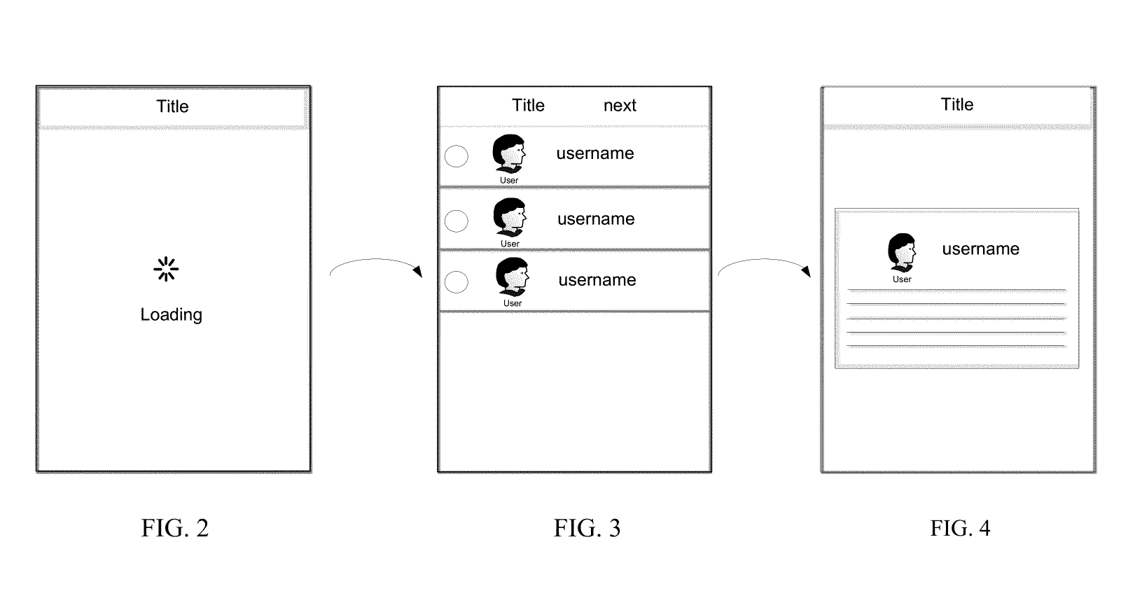

The sending terminal is a mobile terminal that sends out the business card and the receiving terminal is a mobile terminal that receives the business card. Herein, the sending terminal may establish a connection with the receiving terminal by means of near field communication (for example, Bluetooth or WiFi) or by means of remote communication (for example, 2G or 3G communication). Depending on different network environments, the communication may need to be relayed by a server. FIG. 2 shows an interface when a sending terminal and a receiving terminal enter a business card exchange mode. The interface may be an entry point for a business card exchange program. In addition, when entering the business card exchange mode, the sending terminal receives a request that is sent by the receiving terminal for establishing a connection for sending a business card, and establishes a connection with the receiving terminal according to the request, where the request includes a user identifier of the receiving terminal. In some embodiments, the request is generated after the process during which the sending terminal receives a business card from the receiving terminal (in other words, the sending terminal was the receiving terminal while the receiving terminal was the sending terminal). Certainly, the sending terminal may also actively send a request for establishing a connection for sending a business card to the receiving terminal.

In step S102, a receiving terminal list is displayed on a display of the sending terminal, the receiving terminal list including user identifiers of receiving terminals. For example, the display is a touch screen that can detect user inputs through finger gestures on the touch screen.

In this embodiment of the present disclosure, after entering the business card exchange mode, the sending terminal displays a business card receiving terminal list, for example, displays a contact list that is in the mobile terminal, or displays a list of terminals that have started the business card exchange program in near field communication. The receiving terminal list includes user identifiers of receiving terminals. The user identifier may be a device name, or may be a user name that is displayed when the business card exchange program is installed and started.

In step 103, after a user selection operation of selecting at least one user identifier in the receiving terminal list is received by the sending terminal, a business card is displayed on the display of the sending terminal.

In this embodiment of the present disclosure, by means of a finger tap event on the display of the sending terminal (that is, the selection operation), at least one user identifier in the receiving terminal list is selected, that is, one or more receiving objects are selected, so as to avoid sending the business card to an undesired receiving terminal. In this case, one receiving terminal or multiple receiving terminals may be selected. As shown in FIG. 3 and FIG. 4, after the user selects a user identifier according to needs, the sending terminal displays a business card to be exchanged, that is, a business card of the user of the sending terminal. The business card may be presented in many forms, for example, a business card dedicated for business purposes or a business card (which includes a hobby, a home address, and the like) dedicated for social purposes.

In step S104, a sliding operation performed on the business card on the sending terminal is received by the sending terminal and the business card in the sending terminal is sent to the receiving terminal that corresponds to the selected user identifier.

According to this embodiment of the present disclosure, the sliding operation performed on the business card on the sending terminal is received, and by means of the sliding operation, the business card in the sending terminal is moved, so that the business card in the sending terminal is sent to the receiving terminal that corresponds to the selected user identifier. The receiving terminal receives the business card in the sending terminal. Such an operation manner of sending a business card is simple and intuitive. Preferably, the moving direction of the business card in the sending terminal is consistent with the sliding direction of a finger of the user, making the operation more intuitive.

Based on the above, a business card exchange program is started immediately after a sending terminal and a receiving terminal enter a business card exchange mode, as shown in FIG. 2. Afterward, a user identifier of a receiving terminal is selected according to needs, as shown in FIG. 3. Then, a business card in the sending terminal pops up, as shown in FIG. 4. Finally, a finger of a user slides on a screen of the sending terminal, and the sending terminal receives a sliding operation that makes the business card move, and sends the business card to a related receiving terminal. The entire operation is simple and intuitive.

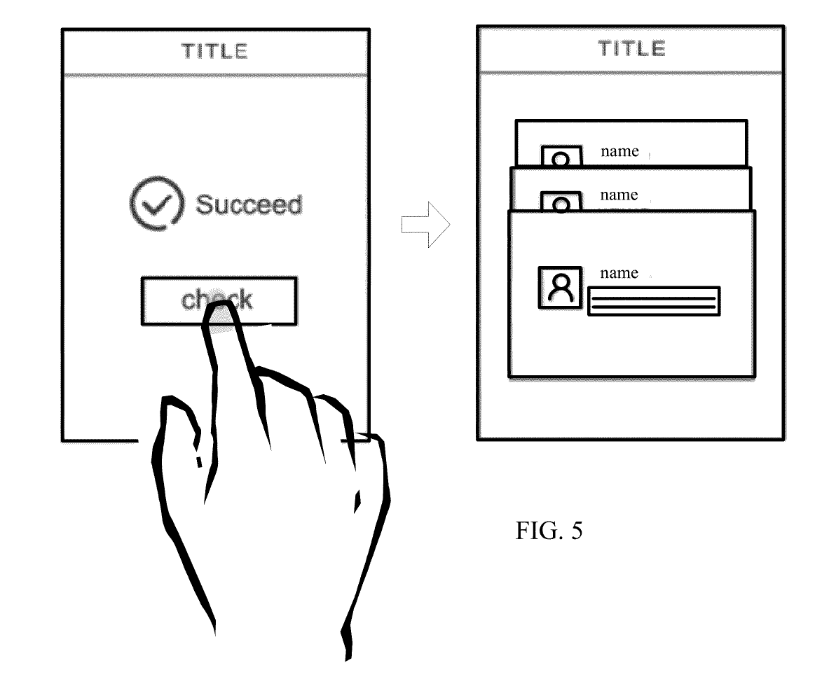

In addition, the business card receiving terminal checks all received business cards by means of a checking event. For example, the user can check all received business cards by clicking a “check” button in an interface of a mobile phone, as shown in FIG. 5.

### Embodiment 2

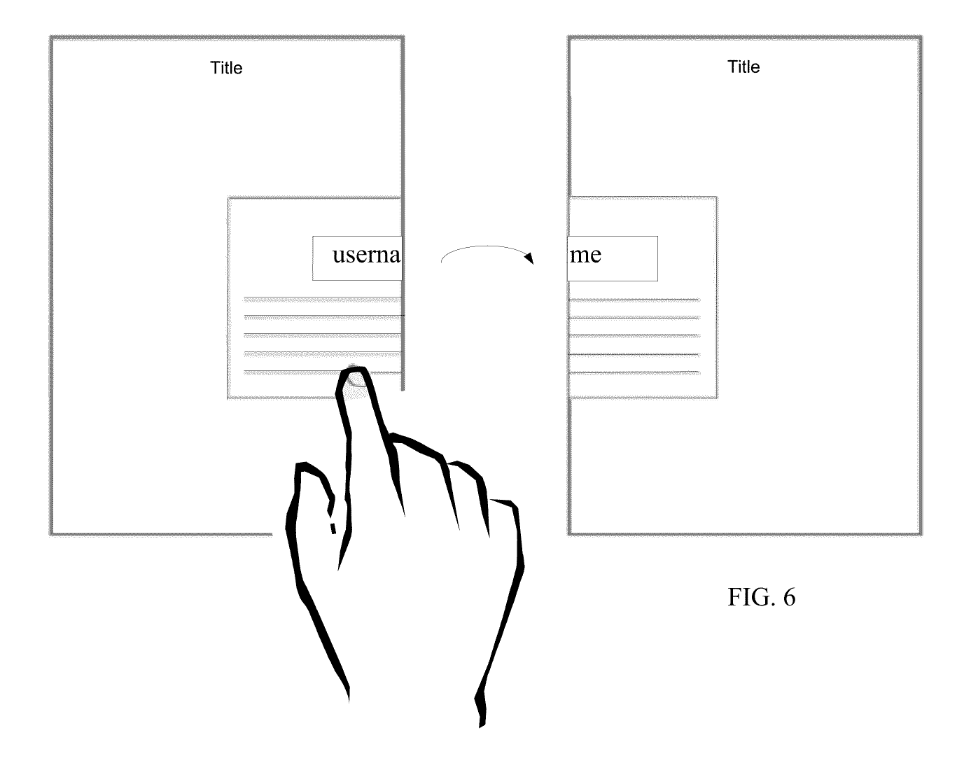

In this embodiment, the business card in the sending terminal is moved by means of the sliding operation. While at least one portion of the business card is dynamically removed out of the screen of the sending terminal, the same portion of the business card is sent to the receiving terminal in real time, so that the receiving terminal receives and dynamically displays the part in real time (that is, the part of the business card that disappears from the screen of the sending terminal is gradually drawn on the screen of the business card receiving terminal) until the entire business card is removed out of the screen of the sending terminal, as shown in FIG. 6. After the entire business card is sent, the receiving terminal displays a complete business card from the sending terminal. In some embodiments (not displayed in FIG. 6), the user identifier of the receiving terminal is shown along with the remaining portion of the business card on the display of the sending terminal while the business card is dynamically removed from the screen of the sending terminal. Similarly, the user identifier of the sending terminal is shown along with the arriving portion of the business card on the display of the receiving terminal while the business card is received by the receiving terminal. This further makes the exchange of a business card simpler and more intuitive.

For ease of operation, the entire business card can be sent out when the displacement of the business card exceeds two thirds of the length of the business card.

### Embodiment 3

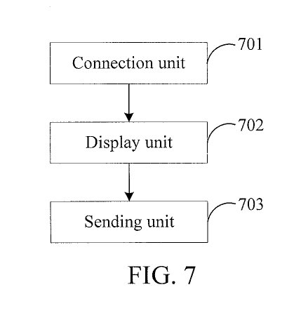

FIG. 7 shows a structure of an apparatus for exchanging business cards between mobile terminals according to this embodiment of the present disclosure. The apparatus includes one or more processors, memory, and a plurality of program units stored in the memory and for execution by the one or more processors, the plurality of program units further including a connection unit 701, a display unit 702, and a sending unit 703. The connection unit 701 is configured to enable a sending terminal to establish a connection with a receiving terminal and enter a business card exchange mode. The display unit 702 is configured to display a receiving terminal list and display, after a selection operation of selecting at least one user identifier in the receiving terminal list is received, a business card on the sending terminal. The sending unit 703 is configured to receive a sliding operation performed on the business card on the sending terminal and send the business card in the sending terminal to a receiving terminal that corresponds to the selected user identifier. Herein, the business card is an image stored in a mobile terminal and used for carrying personal information, and the receiving terminal list includes user identifiers of receiving terminals.

The apparatus for exchanging business cards between mobile terminals is integrated into a sending terminal, and the display unit is a display screen of the sending terminal.

For ease of operation, the apparatus further includes a clicking unit configured to receive the selection operation, a sliding operation unit configured to receive the sliding operation, a checking unit configured to receive a checking event, and a movement unit configured to move the business card in the sending terminal by means of the sliding operation and send a part, which is moved out of a screen of the sending terminal, of the business card to the receiving terminal in real time, so that the receiving terminal receives and displays the part in real time until the entire business card is moved out of the screen of the sending terminal. To achieve “What You See Is What You Get”, the apparatus further includes a drawing unit configured to draw a business card.

It should be noted that the specific working principles of the foregoing units are as described above, and the details are not described herein again. In addition, each of the units of the apparatus for exchanging business cards between mobile terminals may be a software unit, a hardware unit, or a unit combining software and hardware. The software unit part may be stored in a non-transitory computer readable storage medium, for example, a ROM/RAM, a magnetic disk, an optical disc, or the like.

An embodiment of the present disclosure further provides a non-transitory storage medium including a computer executable instruction, the computer executable instruction being used for being executed by a processor to perform a method for exchanging business cards between mobile terminals, the method including the following steps:

establishing, by a sending terminal, a connection with a receiving terminal, and entering a business card exchange mode;

displaying a receiving terminal list, the receiving terminal list including user identifiers of receiving terminals;

displaying a business card on the sending terminal, after a selection operation of selecting at least one user identifier in the receiving terminal list is received; and

receiving a sliding operation performed on the business card on the sending terminal and sending the business card in the sending terminal to the receiving terminal that corresponds to the selected user identifier.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for exchanging business cards between mobile terminals, comprising:
at a sending terminal having one or more processors and memory for storing a plurality of program units for execution by the one or more processors:
establishing a wireless connection with one or more receiving terminals and entering a business card exchange mode with the one or more receiving terminals;
displaying a receiving terminal list, the receiving terminal list comprising user identifiers of the one or more receiving terminals;
displaying a business card on a display of the sending terminal in response to a user selection operation of selecting at least one user identifier in the receiving terminal list; and
sending the business card from the sending terminal to the receiving terminal that corresponds to the selected user identifier through the wireless connection after receiving a sliding operation performed on the business card on the display of the sending terminal.

2. The method according to claim 1, wherein sending the business card from the sending terminal to the receiving terminal further includes dynamically removing at least one portion of the business card from the display of the sending terminal until the business card disappears from the display of the sending terminal while the at least one portion of the business card is dynamically displayed on a display of the receiving terminal in real time.

3. The method according to claim 1, wherein the selection operation is a finger tap event on the display of the sending terminal and the user identifier is a user name of the receiving terminal.

4. The method according to claim 3, wherein the business card is formed by pulling user information by a built-in code compilation template.

5. The method according to claim 4, wherein the user information comprises a user name of a mobile terminal, a mobile terminal number, and/or an instant messaging account.

6. The method according to claim 1, wherein the sending terminal enters the business card exchange mode after receiving a request from at least one of the one or more receiving terminals, the request including the user identifier of the receiving terminal sending the request.

7. The method according to claim 1, wherein the sending terminal enters the business card exchange mode after receiving a business card from at least one of the one or more receiving terminals.

8. A mobile terminal, comprising:
one or more processors;
memory; and
a plurality of program units stored in the memory and for execution by the one or more processors, the plurality of program units further including:
a wireless connection unit, configured to establish a wireless connection with one or more receiving terminals and enter a business card exchange mode with the one or more receiving terminals;
a display unit, configured to display a receiving terminal list, the receiving terminal list comprising user identifiers of the one or more receiving terminals, and display a business card on a display of the mobile terminal in response to a user selection operation of selecting at least one user identifier in the receiving terminal list; and
a sending unit, configured to send the business card from the mobile terminal to the receiving terminal that corresponds to the selected user identifier through the wireless connection after receiving a sliding operation performed on the business card on the display of the mobile terminal.

9. The mobile terminal according to claim 8, wherein the plurality of program units further include a movement unit configured to dynamically remove at least one portion of the business card from the display of the mobile terminal until the business card disappears from the display of the mobile terminal while the at least one portion of the business card is dynamically displayed on a display of the receiving terminal in real time.

10. The mobile terminal according to claim 8, wherein the plurality of program units further include a drawing unit configured to draw a business card on the display of the mobile terminal.

11. The mobile terminal according to claim 10, wherein the selection operation is a finger tap event on the display of the mobile terminal and the user identifier is a user name of the receiving terminal.

12. The mobile terminal according to claim 11, wherein the business card is formed by pulling user information by a built-in code compilation template.

13. The mobile terminal according to claim 12, wherein the user information comprises a user name of a mobile terminal, a mobile terminal number, and/or an instant messaging account.

14. The mobile terminal according to claim 8, wherein the wireless connection unit is activated after the mobile terminal receives a request from at least one of the one or more receiving terminals, the request including the user identifier of the receiving terminal sending the request.

15. The mobile terminal according to claim 8, wherein the wireless connection unit is activated after the mobile terminal receives a business card from at least one of the one or more receiving terminals.

16. A non-transitory storage medium comprising a plurality of computer executable instructions, the computer executable instructions being executed by one or more processors of a sending terminal for exchanging business cards with one or more receiving terminals, the computer executable instructions further including:
establishing a wireless connection with one or more receiving terminals and entering a business card exchange mode with the one or more receiving terminals;
displaying a receiving terminal list, the receiving terminal list comprising user identifiers of the one or more receiving terminals;
displaying a business card on a display of the sending terminal in response to a user selection operation of selecting at least one user identifier in the receiving terminal list; and
sending the business card from the sending terminal to the receiving terminal that corresponds to the selected user identifier through the wireless connection after receiving a sliding operation performed on the business card on the display of the sending terminal.

17. The non-transitory storage medium according to claim 16, wherein the instruction for sending the business card from the sending terminal to the receiving terminal further includes instructions for dynamically removing at least one portion of the business card from the display of the sending terminal until the business card disappears from the display of the sending terminal while the at least one portion of the business card is dynamically displayed on a display of the receiving terminal in real time.

18. The non-transitory storage medium according to claim 16, wherein the selection operation is a finger tap event on the display of the sending terminal and the user identifier is a user name of the receiving terminal.

19. The non-transitory storage medium according to claim 16, wherein the sending terminal is configured to enter the business card exchange mode after receiving a request from at least one of the one or more receiving terminals, the request including the user identifier of the receiving terminal sending the request.

20. The non-transitory storage medium according to claim 16, wherein the sending terminal is configured to enter the business card exchange mode after receiving a business card from at least one of the one or more receiving terminals.
